(19) United States
(12) Patent Application Publication
(10) Pub. No.: US 2017/0320608 A1
(43) Pub. Date: Nov. 9, 2017

(54) METHOD AND MACHINE FOR FORMING A BOX BY PLACEMENT ON A V-SHAPED SUPPORT

(71) Applicant: DS SMITH PACKAGING FRANCE, Puteaux (FR)

(72) Inventor: Eric Schuster, Thorey en Plaine (FR)

(73) Assignee: DS SMITH PACKAGING FRANCE, Puteaux (FR)

(21) Appl. No.: 15/526,915

(22) PCT Filed: Nov. 19, 2015
(86) PCT No.: PCT/FR2015/053143

§ 371 Date: May 15, 2017

(30) Foreign Application Priority Data
Nov. 20, 2014 (FR) 1461223

(51) Int. Cl. B65B 43/26; B31B 2110/35; B31B 50/36; B31B 50/28; B31B 2100/00

(52) U.S. Cl. CPC B65B 43/265; B31B 50/282; B31B 2100/0022; B31B 50/36; B31B 2110/35

(57) ABSTRACT

A method and a machine for forming a box from a blank, in which the blank is removed from a storage magazine by suction, the blank is fed horizontally above a support having an upper edge with a V-shaped cross section and faces that correspond to the main walls and are inclined with respect to the horizontal by a given angle a, such that the central folding line, known as the reference folding line, is next to the edge, the blank is placed on the support, the blank is then pressed against a polygonal mandrel, the upper edge of which coincides with and/or is in line with the upper edge of the support, said mandrel having a shape complementary to that of the box, so as to form a tubular box body at an angle to the horizontal, the bottom of the box is formed by folding and pressing together flaps after application of glue, and the inclined box thus formed is ejected, is positioned upright and then is transferred to a filling station.

The present invention relates to a method for forming a box from a blank comprising a sequence of four main rectangular walls ending in a gluing tab, that are linked together by mutually parallel fold lines or by intermediate walls.

The invention also relates to a machine for forming such a box.

The invention can be applied significantly but not exclusively in the domain of packaging objects or groups of objects inserted through the top of the preformed packaging, the packaging being closed, subsequently for example by an attachable cover.

A machine and a method for such formation of a box using a mandrel is already known (U.S. Pat. No. 4,932,930 A).

Although such a machine is satisfactory in enabling notably the rapid manufacture of boxes, for example forty boxes a minute, such a machine has a number of drawbacks.

Indeed, such machines can only be used, with mandrel sizes specifically manufactured for blanks with given dimensions and volumes.

Mandrels of variable shape may be made with retractable mandrels.

Such mandrels nonetheless present drawbacks since they require complex adjustments to the size of the mandrel to enable the relative movement between the different edges of this latter.

The present invention is intended to provide a method and a machine for making a box with a mandrel that addresses the requirements of the art better than those previously known, in particular by enabling the formation of a perfectly square box in a manner that is easy to implement, while enabling the formation of boxes of different dimensions using the same machine.

To do so, the invention is notably based on the idea of using a particular mandrel layout and/or a position and a method for feeding the blank onto same to form a perfectly square box involving wall dimensions that can be easily varied.

The invention is thus highly modular while providing satisfactory precision and good solidity of the box obtained, on account of excellent gluing.

For this purpose, the invention notably proposes a method for forming a box from a blank comprising a sequence of four main rectangular walls ending in a gluing tab that are linked together by first mutually parallel fold lines or by intermediate walls, specifically a first center fold, line or a first intermediate center wall, two first lateral fold lines or two intermediate lateral walls and a first tab fold line or a lateral end wall, and including an assembly of lateral flaps linked at one side of said sequence by second fold lines perpendicular to the first fold lines, to form the bottom of the box,

characterized in that
the blank is extracted from a storage magazine (for example vertical or semi-vertical) by suction,
the blank is conveyed horizontally above a support having an upper edge with a V-shaped or substantially V-shaped cross section and faces corresponding to the main walls that are inclined to the horizontal by a given angle a, such, that the first, center fold line or the intermediate center wall, referred to as the reference center fold line or the reference intermediate center wall, face said edge,
the blank is positioned on the support such that the reference fold line or the reference intermediate wall coincides or substantially coincides with said edge,
the blank is then applied to a polygonal mandrel, the upper edge of which coincides and/or continues in line with the upper edge of the support, the shape of said mandrel fitting the shape of the box, by applying the walls adjacent to said, first reference fold line or to said reference intermediate wall to the opposing upper faces of the mandrel and applying the previously glued end walls and the tab to the opposing lower faces of said mandrel, to form a tubular box body inclined to the horizontal,
the bottom of the box is formed by folding and applying the flaps to one another after gluing,
the inclined box thus formed is ejected,
the box is set upright and transferred to a filling station.

By feeding the blank from the top onto a wedge support having a preformed static reference edge, by simply positioning the blank via the central portion of same, said blank will naturally adopt a first balanced or substantially balanced position on the support, notably under the effect of gravity and/or by simply pressing, without same causing precision, problems when fitting the edges, before authorizing a symmetrical or substantially symmetrical wrapping about the mandrel, this latter having an upper edge that is also V-shaped and that coincides with or continues in line with the upper edge of the support.

In other words f gravity and the weight equilibrium naturally occurring between the two lateral portions of the blank are used. When released onto or applied to the upper edge of the inverted V, said blank naturally balances as if on the blade or thin portion of a cutting element, subsequently enabling easy wrapping, as claimed.

“V-shaped edge” means an edge in which the apex is oriented upwards to form a corner angle with a cross section in the form of a pointed or truncated hat, the angle of the branches of the V being 90°.

“Edge with a substantially V-shaped cross section” means a V-shaped edge in which, the apex is cut to form a horizontal cut corner with one or more sides, or with a rounded apex.

“Semi-vertical magazine” means a magazine storing the blanks inclined at an angle of between 0° and 40° from the vertical, for example 30° (i.e. between 60° and 90° from the horizontal), and advantageously 70°.

In advantageous embodiments, any of the following arrangements can also be used:
The blank is placed on a support having or delimiting faces corresponding to the main walls inclined at the angle α of between 30° and 60° and advantageously at 45° from the horizontal.

The first reference fold line or the reference intermediate wall of the support is positioned by releasing the blank, which falls onto the upper edge under the effect of gravity,
The first reference fold line or the reference intermediate wall is placed on the upper edge of the support by guiding the blank using friction (i.e. conveying same by contact without bearing) onto the top of the edge.

To do so, the space between the guide (for example a metal plate) and the edge is the same as the thickness of the blank and/or of the groove.

Slightly greater pressure may also be exerted, specifically the pressure of the guide bearing slightly on the fold line itself, by compression on the reference edge and/or on the adjacent walls. Advantageously, this compression is slight, i.e. just a few grams, for example between 10 and 20 grams.
The first reference fold line or the reference intermediate wall is positioned on the upper edge of the support by exerting sufficient pressure to enable pressing on the rims of the upper edge or on the surface corresponding to the reference intermediate wall.

To do so, an actuator carried on an extraction arm is for example provided to act before the contribution of the arm, enabling formation of the V.

Such a system is particularly advantageous for heavy paper or paper with scores (fold lines) that are inadequately marked,
The blank is positioned in a first station for positioning on the support, the blank is glued while being moved, and the tubular body of the box and the bottom are formed at a second forming station on the mandrel, before ejecting.
The bottom, formed is pressed to eject the box, and to set the box upright, the box is dropped onto an inclined plate, the box is lifted using a lifter and the box is tilted by pushing laterally on a horizontal upper end plate to position same horizontally, before again tilting the box vertically onto a conveyor belt.

Advantageously, the inclined plate forms a 45° angle with the horizontal.
The adjacent walls of said first center fold line are applied to the opposing upper faces of the mandrel and the previously glued end walls and the tab are applied to the opposing lower faces of said mandrel by two articulated arms.

The invention also proposes a machine implementing the method described above.

The invention, also proposes a machine for forming a box from a blank comprising a sequence of four main rectangular walls ending in a gluing tab that are linked together by first mutually parallel fold lines or by rectangular intermediate walls, specifically a first center fold line or a first intermediate center wall, two first lateral fold lines or two intermediate lateral walls and a first tab fold line or a lateral end wall, and including an assembly of lateral flaps linked at one side of said sequence by second fold lines perpendicular to the first fold lines, to form the bottom of the box,

characterized in that it includes:
Means for extracting the blank from a storage magazine by suction and conveying the blank horizontally above a support,
Said support having an upper edge with a V-shaped or a substantially V-shaped cross section and adjacent faces corresponding to the main walls that are inclined from the horizontal by a given angle a, said extraction and conveyance means being arranged such that the first center fold line or the intermediate center wall, referred to as the reference center fold line and the reference intermediate center wall, face said edge,
Means for controlling the positioning of the blank on the support such that the reference fold line or the reference intermediate wail coincides or substantially coincides with said edge,
Means for forming the box; that coincide with or continue the line of the support including a polygonal mandrel shaped to match the shape of the box,
Means for gluing the flaps and the gluing tab,
Means for applying the walls adjacent to said first reference fold line or to said reference intermediate wall to the opposing upper faces of the mandrel and for applying the previously glued end walls and the tab to the opposing lower faces of said mandrel, to form a tubular box body inclined to the horizontal,
Means for pressing the flaps to form the bottom of the box by folding and applying the flaps to one another after gluing,
Means for ejecting the inclined, box thus formed;
Means for setting the box upright and transferring said box to a filling station.

Advantageously, the mandrel is formed by a frame with three parallel edges attached to one another, and a moveable edge carried on an ejector piston belonging to the ejection means.

In an advantageous embodiment, the edges are formed by a central tipper edge with an inverted-V cross section at an angle of 45° to the horizontal, two lateral edges that can be adjusted (remotely) in relation to the central upper edge, and a lower edge rigidly connected to a moveable removable jig. The lateral edge can thus be moved along the V-shaped slopes of the support and attached at the desired positions, while the jig can foe adjusted to achieve the desired cross section of the box.

Also advantageously, the edges are cut corners.

In an advantageous embodiment, the machine includes a first station for positioning on the support, where the blank is released by the extraction means onto a first portion of the support, transfer means for the blank to convey the blank to a second forming station on a second portion of the support including said mandrel, where the tubular body of the box and the bottom are formed, the gluers enabling lines of adhesive to be applied while the blank is being conveyed from the positioning station to the forming station and means for ejecting the box from the mandrel.

Also advantageously, the means for ejecting the box include internal means for pushing against the internal face of the bottom and external means for suctioning the external face of the bottom.

The pushing means are for example a longitudinal rod or piston actuated longitudinally by a motor and means for suctioning suction cups carried on a plate or a lattice structure and vacuum-fed in an known manner.

In an advantageous embodiment, the means for setting the box upright include an inclined plate designed to receive the ejected box oriented at an angle from the horizontal, a carriage for lifting the inclined plate from the first low receiving position to a second high leveling position, first lateral pushing means arranged to push the box when the inclined plate is in the high position, onto a horizontal upper end plate to horizontally level said box, and second lateral pushing means perpendicular to the first lateral pushing means designed to position said box vertically on a support, arranged to convey same to a packaging station.

The first and second lateral pushing means are for example pusher jacks ending in flat portions designed to be applied, to the opposing face of the box.

Also advantageously, the machine includes two articulated arms arranged to apply the adjacent walls of said first center fold line or the intermediate center wail to the opposing upper faces of the mandrel and the end walls of the previously glued tab are applied to the opposing lower faces of the mandrel.

The invention is further explained in the description below of different embodiments given by way of nonlimiting examples.

The description relates to the attached drawings, in which;

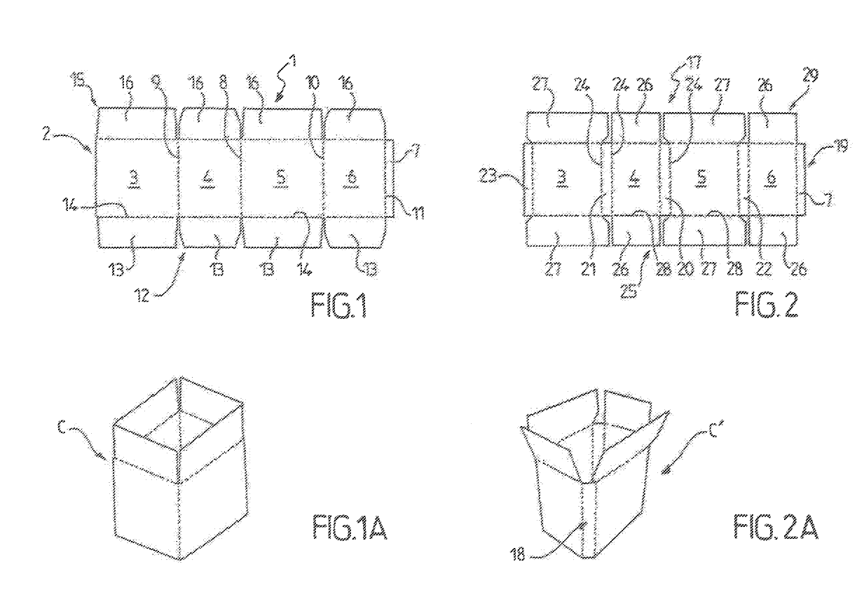

FIGS. 1 and 2 are top views of two embodiments of blanks that can foe used with the method and the machine according to the invention.

FIGS. 1A and 2A are perspective views of boxes obtained from the blanks in FIGS. 1 and 2 formed using the method according to the invention.

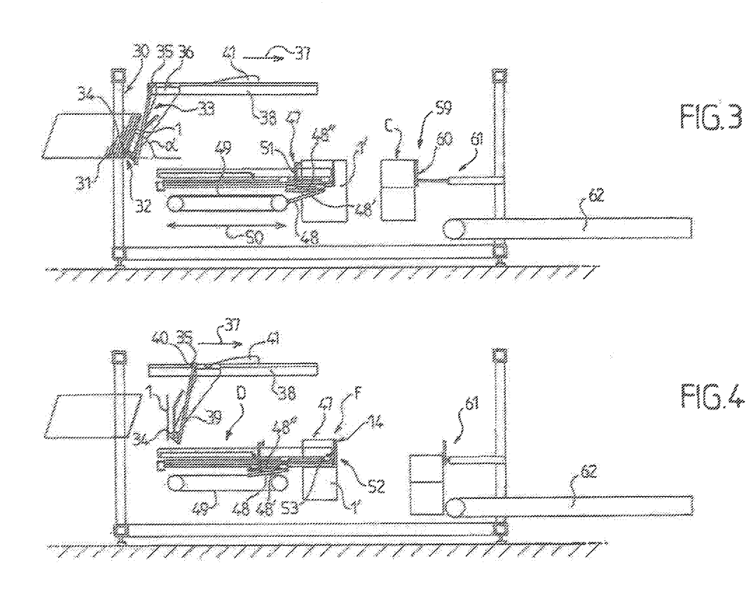

FIGS. 3 to 7 are schematic side views of the main steps implemented in the method according to the embodiment of the invention more specifically described herein.

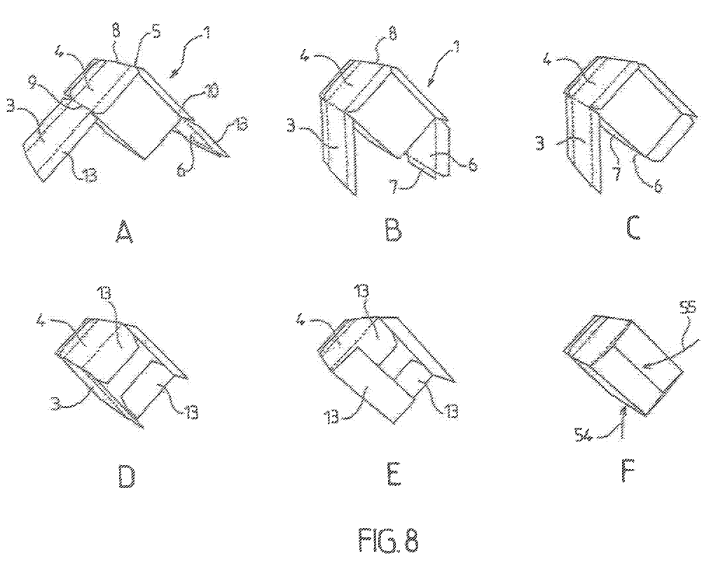

FIG. 8 shows steps A to F for forming the box about the mandrel according to one embodiment of the invention.

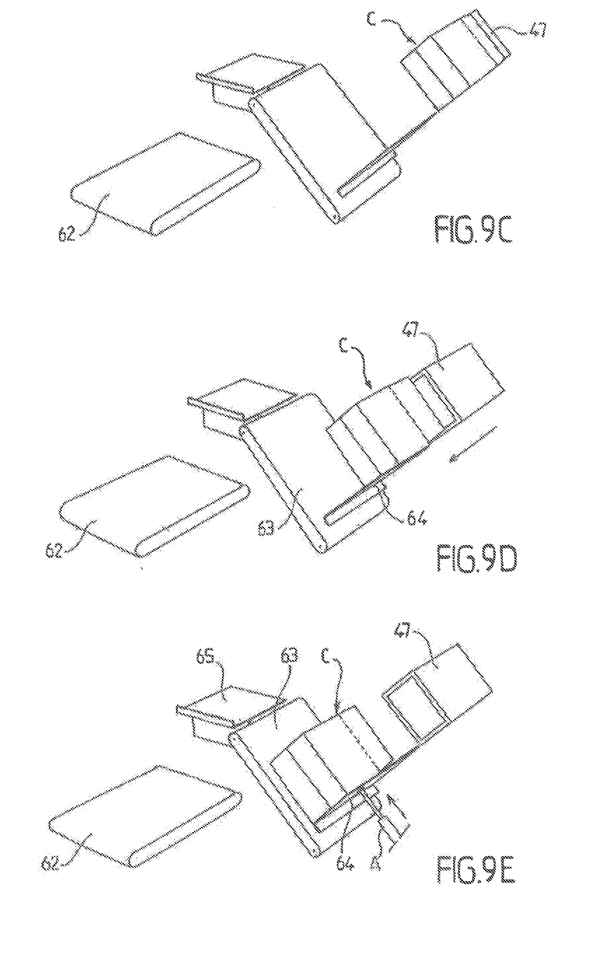

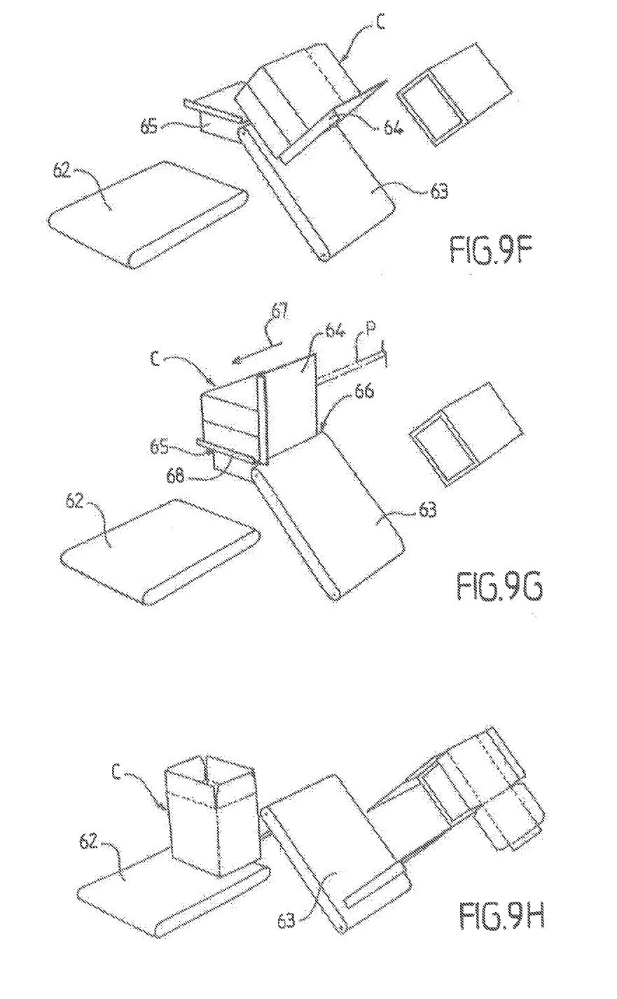

FIGS. 9A to 9H are schematic perspective views of the final steps of the method for tilting and overturning the box after formation towards the following station implemented in one embodiment of the invention.

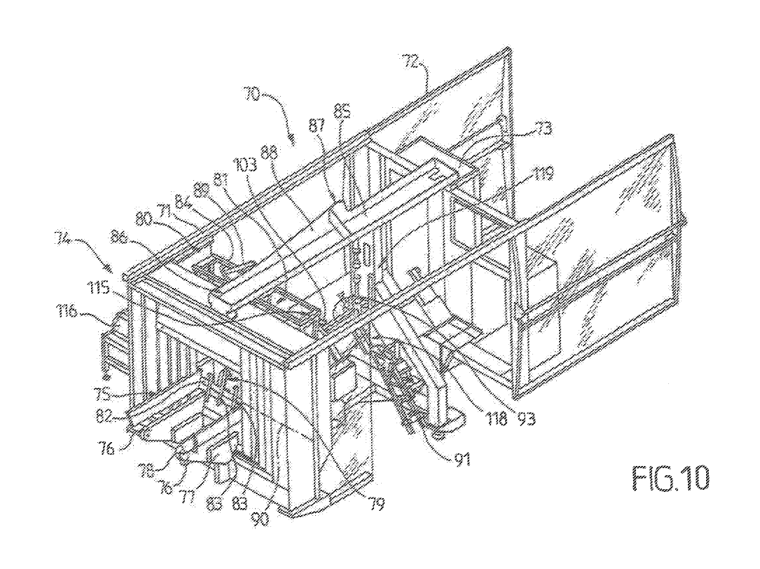

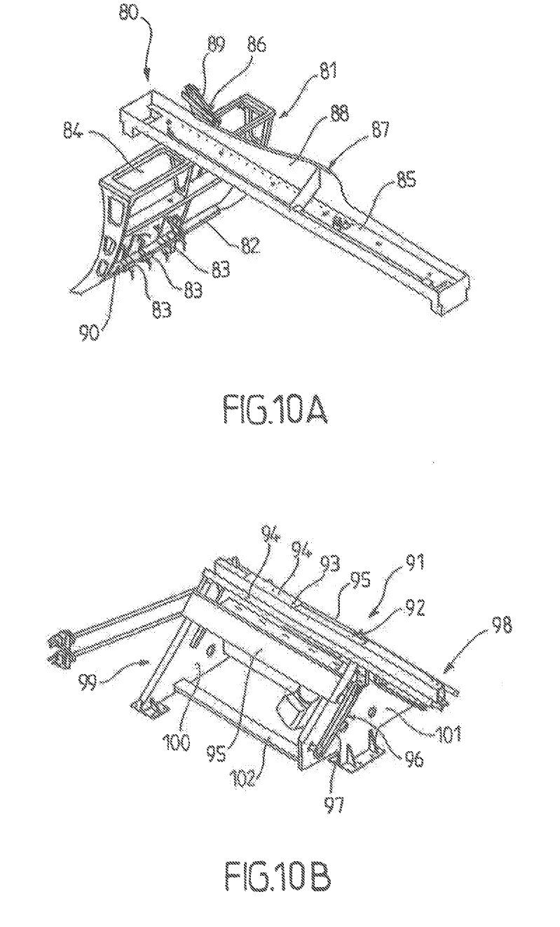

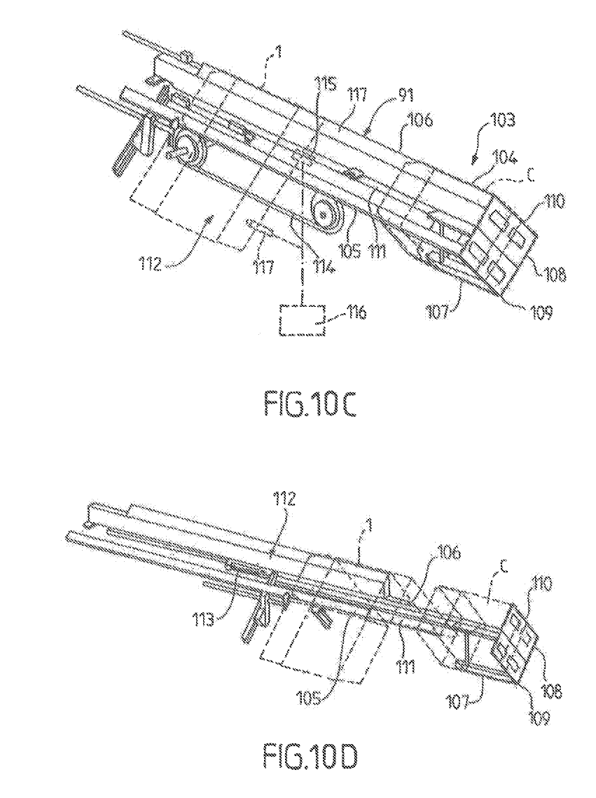

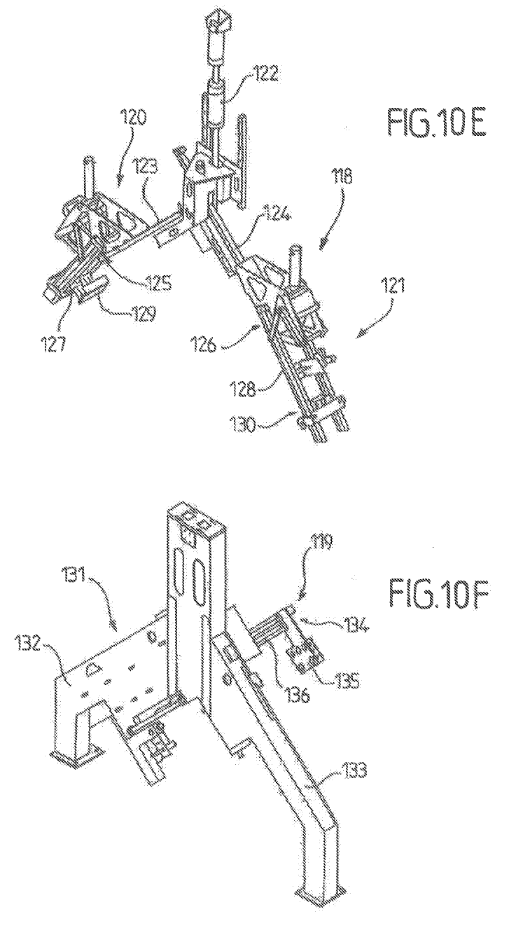

FIG. 10 is a perspective overview of a machine according to the embodiment of the invention more specifically described herein.

FIG. 10A is a perspective view of an embodiment of the means for extracting and positioning blanks belonging to the machine in FIG. 10.

FIG. 10B is a perspective view of the V-shaped support in FIG. 10, according to the embodiment of the invention more specifically described herein.

FIGS. 10C and 10D are perspective views of the end of the V-shaped support and of the mandrel according to the invention usable with the machine in FIG. 10, respectively in the forming position and the ejecting position.

FIG. 10E is a perspective view of an embodiment of the means for applying the walls to the mandrel of the machine in FIG. 10, including two articulated arms.

FIG. 10F shows an embodiment of the means used to form the bottom, of the box belonging to the machine in FIG. 10.

FIG. 1 shows a blank 1 made of double-sided corrugated cardboard, for example with a low grammage (<150 g/m²) and a thickness of 3 mm, intended to form the box C (FIG. 1A).

The blank comprises a sequence 2 of four main rectangular walls 3, 4, 5, 6 ending in a gluing tab 7 and linked together by first mutually parallel fold, lines, specifically a first reference or center fold line 8, two first lateral fold lines 9 and 10, and a first end fold line 11, joined to the tab 7.

In a known manner, the blank includes a first set 12 of rectangular or substantially rectangular flaps 13 linked to the main walls by second fold, lines 14 that are perpendicular to the first fold, lines and designed to form the bottom of the box, and a second set 15 of rectangular or substantially rectangular flaps 16 that are designed to form the top of the box C after filling.

Henceforth, the same reference signs are used to identify the same or similar elements.

FIG. 2 shows another type of blank 17 with eight walls designed to form the eight-sided box C′ (FIG. 2A) with cut corners 18.

The blank 17 includes a sequence 19 of four main rectangular walls 3, 4, 5, 6 joined together by rectangular intermediate walls, specifically a intermediate center wall 20, two intermediate lateral walls 21, 22 and one end wall 23; all linked together and to the main walls by parallel join lines 24, and a tab 7 for gluing to the intermediate end wall 23 (having the same dimensions as said latter intermediate wall 23).

The blank 17 includes a first set 25 of flaps 26, 27 linked to the main walls by two second fold lines 28 perpendicular to the join, lines 24, specifically rectangular flaps 26 and flaps 27 having lateral rims inclined, towards the fold line 28 to coincide with the cut corners 18 when the flaps are folded, in a known manner.

The blank 17 also includes a second set 29 of flaps identical to the first set 25 but that is arranged symmetrically in relation to a longitudinal axis of the blank, designed to form the top of the box.

Other embodiments of the flaps are naturally possible.

FIGS. 3 to 7 show the steps of the method according to the embodiment of the invention more specifically described herein.

Using a magazine 30 of blanks 31 stored in a semi-vertical position (angle α for example around 70°) in a known manner, the blank 1 located at the end 32 of the stack is extracted, using a system 33 of suction cups 34 vacuum-fed in a known manner, and assembled on a pivot pin 35, itself installed on a carriage 36, such as a roller carriage, performing a linear movement (arrow 37) on a horizontal beam or support 38.

The blank is extracted by a movement (see FIGS. 4 and 5) causing the rotation of the suction cups by means of a lever 39 linked to the pivot pin 35 and a roller 40 moving on a cam 41

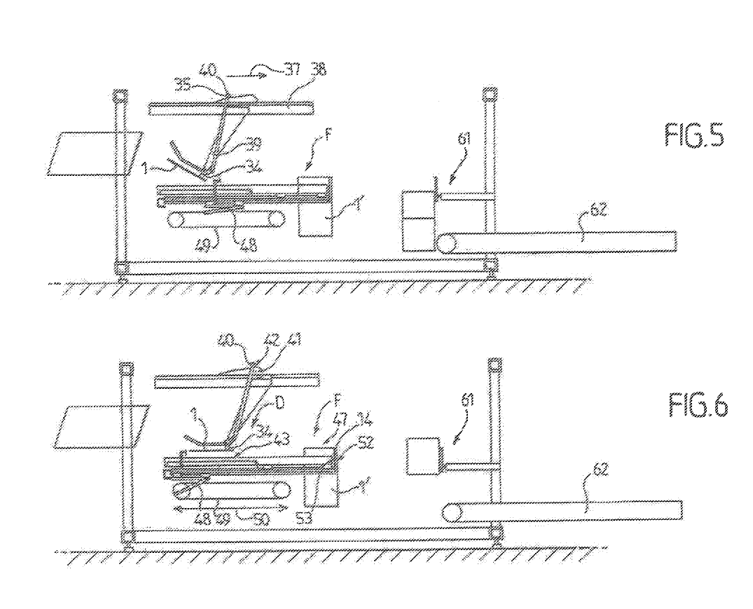

Upon arrival at the forward point. 42 (see FIG. 6), the blank 1 has tilted by around 110° to be positioned horizontally or substantially horizontally above a V-shaped support 43, in this case forming an angle of 45° with the horizontal.

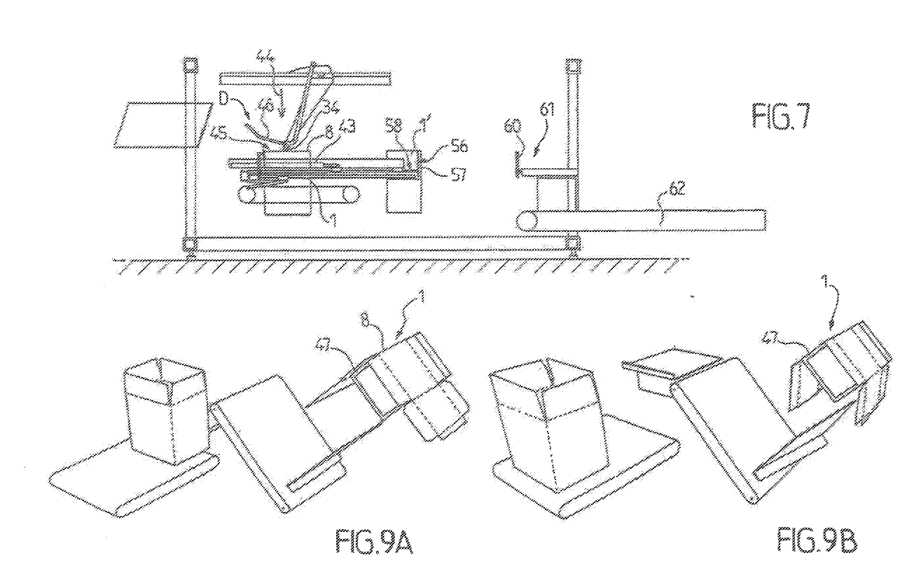

The blank 1 (see FIG. 7) is then released by the suction cups 34 (arrow 44) above the support, the apex of the V or upper edge 45 being the reference edge 8 of the blank (or of the reference panel 20 for an eight-sided blank).

In the embodiment more specifically described, once the blank 1 has been released at the positioning station D, two articulated arms 46 (not yet in the folded position in FIG. 7) carried on the pivot pin perform a first shaping of the box.

The blank indicated using reference sign 1′ at this position is then transferred (see FIG. 4) towards the forming mandrel 47, detailed below, notably with reference to FIGS. 10C and 10D and the following blank 1 starts being conveyed.

Once the blank has adopted a V shape, the blank is conveyed by a transfer carriage 48 to the forming station F.

The transfer carriage is for example formed by two articulated connecting rods 48′ and 48″ specifically a connecting rod 48′ attached at one end to a pin rigidly connected to an endless belt 49 continuously

performing to-and-fro movements, and a connecting rod 48″ joined to the other end rigidly connected to pegs 51 designed to push on the rear rims of the blank to move same horizontal along the support as far as the mandrel 47.

During this transfer, glue is applied to the bottom flaps and to the gluing tab.

Since the blank is positioned with the printed face upwards, the glue is in this case applied by guns (not shown) positioned beneath, the conveyor.

The glue is for example applied by three guns, one for each of the lower bottom, flaps and one for the tab.

As shown, the transfer performed, by the carriage 48 involves an alternating translation movement by chain or belt 43 along a fixed path (arrow 50) of a known type, the final positioning of the blank on the mandrel 47 therefore being determined by the three adjustable pegs 51 carried on the carriage 43.

The forward point 52 of the conveyor corresponds to the alignment of the second fold line 14 of the blank with the front face 53 of the forming mandrel.

Arrival at the forward point 52 triggers the volumizing cycle of the blank about the mandrel, as described below with reference to FIG. 8.

In step A, the blank 1 preformed by the V-shaped support reaches the front stop.

In step B, an upper presser (not shown) is provided to hold the blank on the mandrel.

The movement also causes a first folding of the end walls 3 and 6 or of the intermediate walls in the case of eight-sided boxes.

Subsequently (step C), the panel 6 with the gluing tab 7 and said tab are folded.

In step D, the opposite wall is folded at the same time as the inner flaps 13.

Step E shows the folding of the outer flap 13 on the mandrel, before (step F) the simultaneous pressurization of the gluing tab 7 and the bottom (arrows 54 and 55).

Once the box has been formed, the bottom pressing system opens, triggering ejection of the formed box.

To do so (see FIG. 7), a push carriage 56, including a plate 57 for pressurizing the inside of the bottom of the box, is actuated mechanically using the transfer carriage 48 (see FIGS. 5, 6), with which it is constrained to move longitudinally.

The starting of the carriage is in this case designed to release the ejector piston 58 (see FIG. 7).

In the example more specifically described here, the ejection route is covered by two successive devices, specifically a first device in the mandrel (piston 58) that pushes via the bottom of the box, and a second device 59 (see FIG. 3) that is located on the outside and that engages the box using a set 60 of suction cups that can be attached to the bottom flaps.

The box is then conveyed to the station 61 used to set the box upright and to discharge same to a conveyor belt 62 of a known type.

The righting operation performed by the station 61 is described below with reference to FIGS. 9A to 9H,

FIGS. 9A to 9C firstly show schematically (to the right of the drawings) completion of the formation of the blank 1 about the mandrel 47 to form the box C.

The box is then ejected (FIG. 9D) by external gripping and internal pushing as far as the plate 63 inclined at 45° and provided with a lower guide stop (for example a plate 64) parallel to the box onto which same bears (FIG. 9E).

The box C is then conveyed along the slope of the inclined plate 64 using actuating means A (for example a set of hydraulic jacks) moving the guide stop or plate 64 between a low position for receiving the box and a high tilting position.

The means for actuating the plate thus form a lifting carriage actuated in a known manner.

The stop plate 64 is then tilted vertically (FIGS. 9F and 9G) to push the box C laterally, causing same to fall onto the horizontal plate 65 positioned at the upper end 66 of the plate 63.

The horizontal pushing means P (shown using a mixed line in FIG. 9G) (hydraulic jacks, for example) are actuated along the Arrow 67 to again tilt the box C then in the vertical position, using for example a bar 68 (“tripping” same) onto the conveyor belt 62 leading to a filling station.

A machine 70 (and the main component parts of same) for forming a box from a blank according to the embodiment of the invention more specifically described here is described below with reference to FIGS. 10 and 10A to 10E.

The machine 70 includes a frame or structure 71 forming a platform carrying independent sub-assemblies (or modules) assembled to perform the different functions of the method described above.

These modules are for example marked and positioned using machined hats to guarantee reproducibility of assembly.

The first module is formed by the frame 71. Which is provided with an electrical cabinet door 72, the corresponding cabinet 73 including a programmable logic controller of a known type used to control the machine.

The second module 74 is formed by the magazine 75 for storing the blanks to be formed in a semi-vertical position (70°).

The magazine includes two modular chains 76 driven by a pneumatic system 77.

The chains 76 are for example coupled to a free wheel 78 and enable a blank to be kept ready to be fed at the front portion 79.

Inside the magazine 75, the blanks are stored with the non-printed face outwards and the inside gluing tab to the left in the direction of movement.

The third extraction module 80 (see also FIG. 10A) includes a substantially U-shaped fork 81 that is curved at the end of the branches of same and provided with a lower horizontal bar 82 carrying the suction cups 83, for example four suction cups, vacuum-fed in a known manner, and an upper horizontal bar 84 in the form of a lattice beam.

The fork 81 can be moved longitudinally on a longitudinal beam 85 (38 in FIGS. 3 to 7) between a gripping position 86 and a release position 87.

To do so, the upper portion of the beam 85 has a cam 88 with a gradual upward slope towards the output of the box, actuated via an articulated arm 89 of the lower horizontal bar 82 which mechanically pivots the suction cups about an axis 90 to position the blank horizontally (see FIGS. 4 to 6).

The machine according to the embodiment of the invention more specifically described herein also includes a transfer/ejection/mandrel-holder system 91 (FIG. 10B) forming the positioning portion.

The system 91 includes the inverted V-shaped support 92 that is designed to be positioned beneath the central edge of the blank.

The V-shaped support for a rectangular box includes an upper edge 93 forming a 90° angle (or in the form of a beam of limited width equal to the width of the cut corner for an eight-sided box) and two upper metal blades 94 that are parallel and symmetrical about a central vertical plane, said blades being positioned in the plains forming a 45° angle with the vertical plane to form the starts of the lateral faces of the blank (oriented at 45°).

Two parallel longitudinal plates 95 continuing the line are used as counter guides for the walls adjacent to the positioning station.

A height adjustment device for these inclined plates, for example using loop chains 37, is provided.

The system 91 includes a mandrel-holder end 98 and a mechanical support 99 including two lateral support uprights 100, 101 in the form of triangular plates that are strengthened by two longitudinal side members 102 positioned between same, specifically an end plate 100 and an intermediate plate 101, the end of which enabling passage of the edge of the V-shaped support to form a portion of the mandrel 103.

A quadrangular or octagonal mandrel 103 is placed at the end 98 of the inverted V-shaped support, which is described in greater detail, below with reference to FIGS. 10C and 10D.

The mandrel 103 includes a static V shaped edge 104 the top of which is located in t;he continuation of the upper edge 93 of the system 91 and two adjustable corner-shaped edges 105, 106 (in this case at 90°) located on either side of the central edge at corresponding distances to coincide with the first fold line 9, 10 or join line 24.

The mandrel also includes a fourth movable edge 107 that is rigidly connected to a box ejection plate 108 and attached at the corner 109 of said plate, said plate having the same dimensions (or being slightly smaller) than the bottom of the box.

The plate 108 is mounted removably and designed to adapt to the sizes of the boxes, and is attached using a centering pin to the end 110 of a movable ejector-holder rail 111.

The mandrel therefore comprises a reference edge 104 on which the blank is folded to 90° at the extraction

station, two adjustable edges 105, 106 with right angles or cut corners depending on the box type, that adapt on either side of the reference as a function of the size of the box being formed, and an edge 107 rigidly connected to the ejection plate 108, which is part of the tools as a function of the cross section of the box.

The system 91 in turn includes a box ejection system 112 formed by a sliding rule actuated by a chain or belt 114 (chain 49 in FIGS. 3 to 6) in a known manner, performing a to-and-fro movement.

Gluing means 115 are provided between the positioning station and the mandrel, comprising a tank 116 of hot-melt glue and three injection guns 117 (shown schematically using a mixed line in FIG. 10C) to apply lines of glue to the bottom flaps and to the gluing tab.

FIGS. 10E and 10F show modules 118 and 119 for volumizing the blank about the mandrel and pressing the bottom respectively.

The module 118 includes two articulated arms 120 and 121 including a vertical support part 122 that is moveable vertically in a known manner, to which the two pivoting arms are attached.

Each arm has a rod 123, 124 provided with an intermediate joint 125, 126 enabling the end or intermediate panels to be folded (eight-sided box) and a distal member 127, 128. The respective end portions of same are provided with application shoes 129, 130 used to fold the top wall (129) and the wall with the gluing tab and said gluing tab (130).

The module 119 includes (see FIG. 10F) an inverted V-shaped structure 131 with two lateral arms 132 and 133 and a moveable part 134 in the form of a plate 135 moveable, for example by a jack 136, to simultaneously pressurize the gluing foot and the bottom.

Operation of the machine for forming a box is described below, with reference to the figures.

A first blank 1 is extracted from the blank storage magazine 30, then tilted to the horizontal. The blank is then released onto the upper edge of the support.

The centered position of the blank and gravity, potentially aided by lateral folding using the pivoting arms 46 in the vertical plane, gives the blank an initial V-shape.

The blank is then conveyed to the forming station, pushed by the wedge pegs 51 as far as the mandrel, which at this moment is in the raised position.

The inside of the flaps and the tab are glued during conveyance using the guns.

The walls are then formed and the belt is closed by pressing on the sides using the module 118.

Pressure is then applied to finish the glued tab and the outer flaps to form the bottom with the module 119.

The ejection system is then engaged axid the inclined box pushed on one side via the lower face of the bottom of same and suctioned on the other side via the external face, moves to the station 61 for tilting and discharging the open box, which is then set vertically upright.

Naturally, and in consideration of the foregoing, the present invention, is not limited to the embodiments more specifically described. Indeed, the invention also covers all possible variants, notably those in which the blanks are tilted in a different manner.

1. A method for forming a box from a blank comprising a sequence of four main rectangular walls ending in a gluing tab that are linked together by first mutually parallel fold lines or by intermediate walls, including a first center fold line or a first intermediate center wall, two first lateral fold lines or two intermediate lateral walls and a first tab fold line or a lateral end wall, and further including an assembly of lateral flaps linked at one side of said sequence by second fold lines perpendicular to the first fold lines, to form the bottom of the box, the method comprising:
extracting the blank from a storage magazine by suction,
conveying the blank horizontally above a support having an upper edge with a V-shaped or substantially V-shaped cross section and faces corresponding to the main walls that are inclined to the horizontal by a given angle α, such that the first center fold line or the intermediate center wall, referred to as the reference center fold line or the reference intermediate center wall, face said edge,
positioning the blank on the support such that the reference fold line or the reference intermediate wall coincides or substantially coincides with said edge,
applying the blank to a polygonal mandrel, the upper edge of which coincides and/or continues in line with the upper edge of the support, the shape of said mandrel fitting the shape of the box, by applying the walls adjacent to said reference center fold line or to said reference intermediate wall to the opposing upper faces of the mandrel and applying the previously glued end walls and the tab to the opposing lower faces of said mandrel, to form a tubular box body inclined to the horizontal,
forming the bottom of the box by folding and applying the flaps to one another after gluing,
ejecting the inclined box,
setting the box is-set upright and transferring the box to a filling station.

2. The method as claimed in claim 1, wherein the support having or delimiting faces corresponding to the main walls is inclined at an angle of between 30° and 60° from the horizontal.

3. The method as claimed in claim 2, characterized in that wherein the angle α is 45°.

4. The method according to claim 1, wherein the first reference fold line or the reference intermediate wall of the support is positioned by releasing the blank, which falls onto the upper edge under the effect of gravity.

5. The method as claimed in claim 1, wherein the first reference fold line or the reference intermediate wall is positioned on the upper edge of the support by guiding the blank by friction onto the top of the edge.

6. The method according to claim 1, wherein the blank is positioned in a first station for positioning on the support, the blank is glued while being moved and the tubular body of the box and the bottom are formed at a second forming station on the mandrel, before said ejecting.

7. The method as claimed in claim 6, wherein the formed bottom is pressed to eject the box, and to set the box upright, the box is dropped onto an inclined plate, the box is lifted using a lifting carriage and the box is tilted by pushing laterally on a horizontal upper end plate to position same horizontally, before again tilting the box vertically onto a conveyor belt.

8. The method as claimed in claim 6, wherein the adjacent walls of said reference center fold line are applied to the opposing upper faces of the mandrel and the previously glued end walls and the tab are applied to the opposing lower faces of the mandrel by two articulated arms.

9. A machine for forming a box from a blank comprising a sequence of four main rectangular walls ending in a gluing tab that are linked together by first mutually parallel fold lines or by rectangular intermediate walls, including a first center fold line or a first intermediate center wall, two first lateral fold lines or two intermediate lateral walls and a first tab fold line or a lateral end wall, and further including an assembly of lateral flaps linked at one side of said sequence by second fold lines perpendicular to the first fold lines, to form the bottom of the box, the machine comprising:
means for extracting the blank from a storage magazine by suction and conveying the blank horizontally above a support, said support having a V-shaped or a substantially V-shaped upper edge and adjacent faces corresponding to the main walls that are inclined from the horizontal, said extraction and conveyance means being arranged such that the first center fold line or the intermediate center wall, referred to as the reference center fold line and the reference intermediate center wall, face said edge:
means for controlling the positioning of the blank on the support such that the reference fold line or the reference intermediate wall coincides or substantially coincides with said edge;
means for forming the box that coincide with or continue the line of the support including a polygonal mandrel shaped to match the shape of the box;
means for gluing the flaps and the gluing tab;
means for applying the walls adjacent to said first reference fold line or to said reference intermediate wall to the opposing upper faces of the mandrel and for applying the previously glued end walls and the tab to the opposing lower faces of said mandrel, to form a tubular box body inclined to the horizontal;
means for pressing the flaps to form the bottom of the box by folding and applying the flaps to one another after gluing;
means for ejecting the inclined box thus formed;
means for setting the box upright and transferring said box to a filling station.

10. The machine as claimed in claim 9, wherein the mandrel is formed by a frame with three parallel edges attached to one another, and a moveable edge carried on an ejector piston belonging to the ejection means.

11. The machine as claimed in claim 10, wherein the edges are formed by a central upper edge with an inverted-V cross section, the angles of the V being 45° to the horizontal, two lateral edges that can be adjusted in relation to the central upper edge, and a lower edge rigidly connected to a moveable removable jig.

12. The machine as claimed in claim 9, wherein the edges are cut corners.

13. The machine as claimed in claim 9, further comprising a first station for positioning on the support, where the blank is released by the extraction means onto a first portion of the support, transfer means for the blank to convey the blank to a second forming station on a second portion of the support including said mandrel, where the tubular body of the box and the bottom are formed, the gluers enabling lines of adhesive to be applied while the blank is being conveyed from the positioning station to the forming station and means for ejecting the box from the mandrel.

14. The machine as claimed in claim 9, wherein the means for ejecting the box include means for pushing the inside of the bottom.

15. The machine as claimed in claim 9, wherein the means for setting the box upright include an inclined plate designed to receive the ejected box oriented at an angle from the horizontal, a carriage for lifting the inclined plate from the first low receiving position to a second high leveling position, first lateral pushing means arranged to push the box when the inclined plate is in the high position, onto a horizontal upper end plate to horizontally level said box, and second lateral pushing means perpendicular to the first lateral pushing means designed to position said box vertically on a support arranged to convey same to a packaging station.

16. The machine as claimed in claim 9, further comprising two articulated arms arranged to apply the adjacent walls of said first center fold line or the intermediate center wall to the opposing upper faces of the mandrel and to apply the previously glued end walls and the tab to the opposing lower faces of said mandrel.
